(19) United States
(12) Patent Application Publication
(10) Pub. No.: US 2026/0251922 A1
(43) Pub. Date: Aug. 27, 2026

(54) OPTICAL DEVICES AND METHODS OF MANUFACTURE

(71) Applicant: Taiwan Semiconductor Manufacturing Co., Ltd., Hsinchu (TW)

(72) Inventors: You-Cheng Lu, Tainan City (TW); Stefan Rusu, Sunnyvale, CA (US); Lan-Chou Cho, Hsinchu (TW); Ming Yang Jung, Kaohsiung City (TW); Tai-Chun Huang, New Taipei City (TW); Ruei-Shen Wang, Hsinchu (TW)

(21) Appl. No.: 19/060,053

(22) Filed: Feb. 21, 2025

(51) Int. Cl. G02F 1/01; G02F 1/21; G02F 1/225

(52) U.S. Cl. CPC G02F 1/0121; G02F 1/212; G02F 1/2257; G02F 2201/20

(57) ABSTRACT

Optical devices and methods of manufacture are presented in which an optical device includes a first optical modulator including a first modulating portion and a second modulating portion. A first driver is electrically connected to the first modulating portion, a second driver is electrically connected to the second modulating portion, and a first delay circuit is connected to the second driver.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices, and ongoing improvements in both the optical devices and the electronic dies are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-5 illustrate formation of a first optical package, in accordance with some embodiments.

FIGS. 6A-6D illustrate an optical modulator with two modulation segments, in accordance with some embodiments.

FIG. 7 illustrates a feedback loop, in accordance with some embodiments.

FIG. 8 illustrates an optical modulator with three modulation segments, in accordance with some embodiments.

FIGS. 9A-9B illustrate an optical modulator with three modulation segments and two delay circuits, in accordance with some embodiments.

FIGS. 10A-10B illustrate an optical modulator with two modulation units with multiple segments, in accordance with some embodiments.

FIGS. 11-14 illustrate formation of a first photonic package, in accordance with some embodiments.

FIGS. 15A-15B illustrate a micro-ring modulator with the first modulating unit and a second modulating unit, in accordance with some embodiments.

FIG. 16 illustrates the micro-ring modulator wherein the second modulating unit has a first portion and a second portion, in accordance with some embodiments.

FIGS. 17A-17D illustrate embodiments in which the micro-ring modulator is an elongated oval, in accordance with some embodiments.

FIGS. 18A-18E illustrate other embodiments of micro-ring modulators, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which delay is added to signals that are being applied to optical modulators in pulse amplitude modulation X (PAMX) structures, such as PAM4 or PAM8 structures. The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

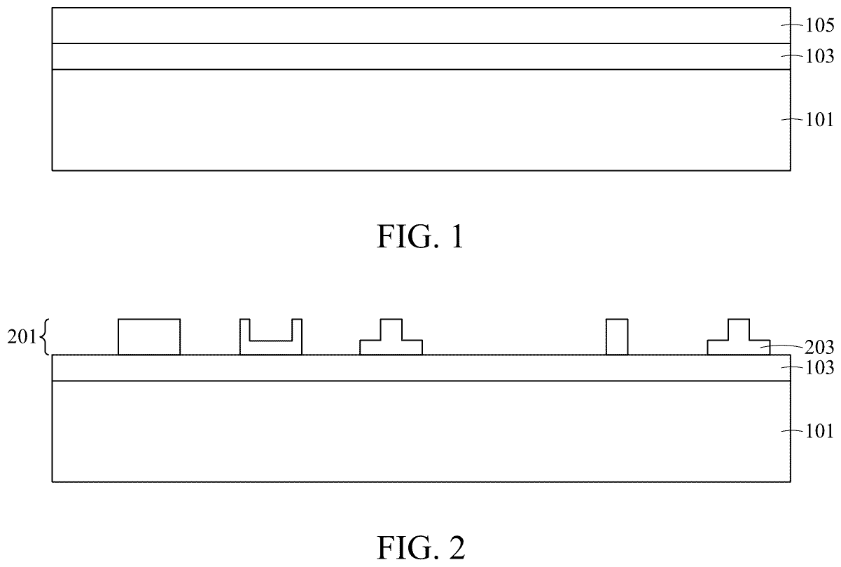

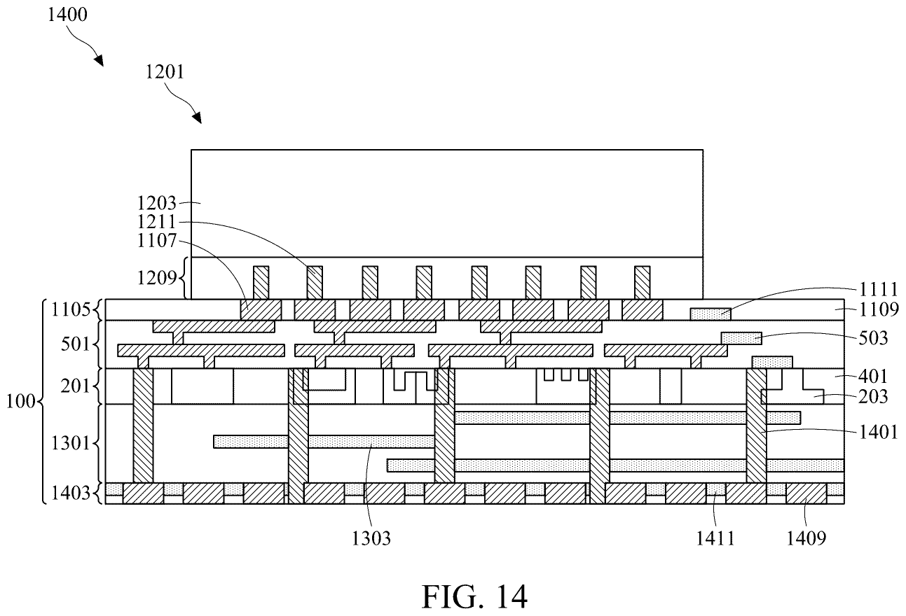

With reference now to FIG. 1, there is illustrated an initial structure of a photonic integrated circuit (PIC) 100 (seen in one completed form in FIG. 14), in accordance with some embodiments. In the particular embodiment illustrated in FIG. 1, the photonic integrated circuit 100 comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the photonic integrated circuit 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

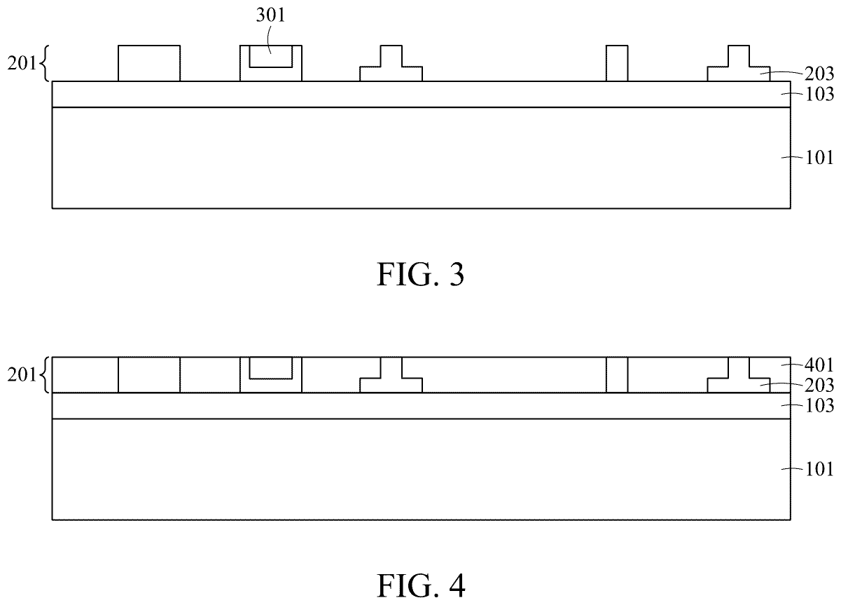

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

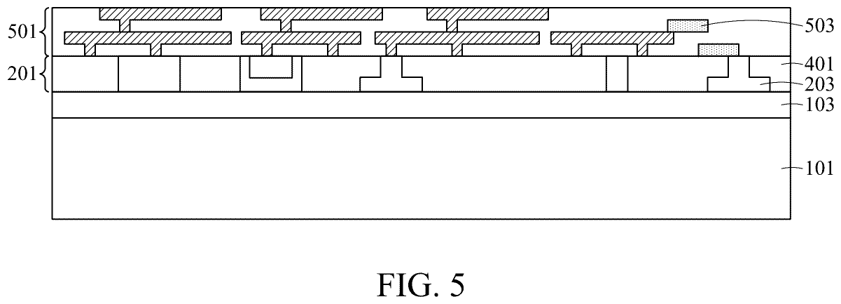

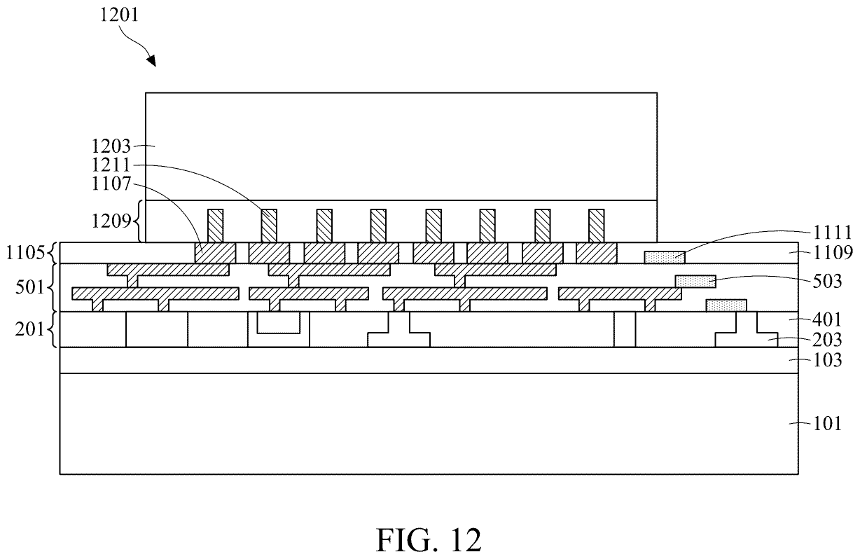

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 12). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the photonic integrated circuit 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

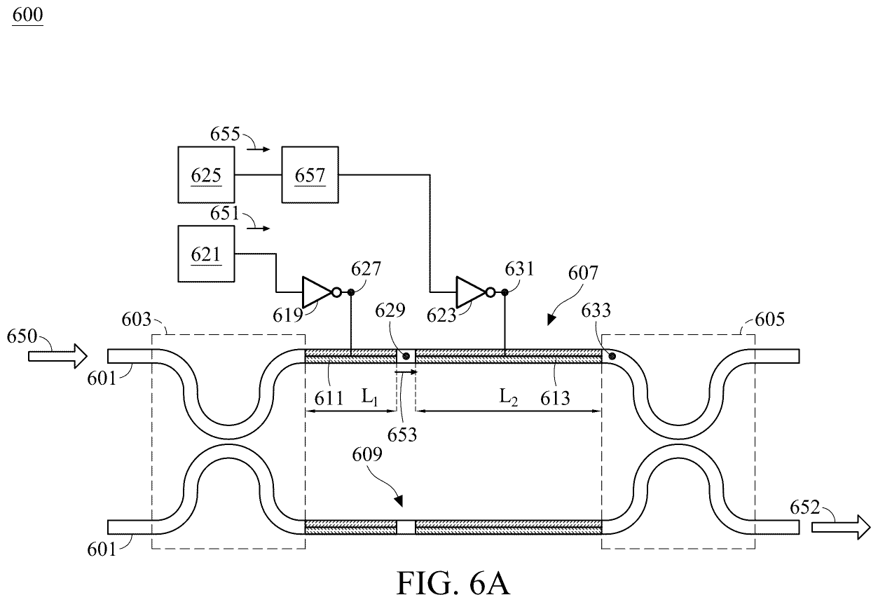

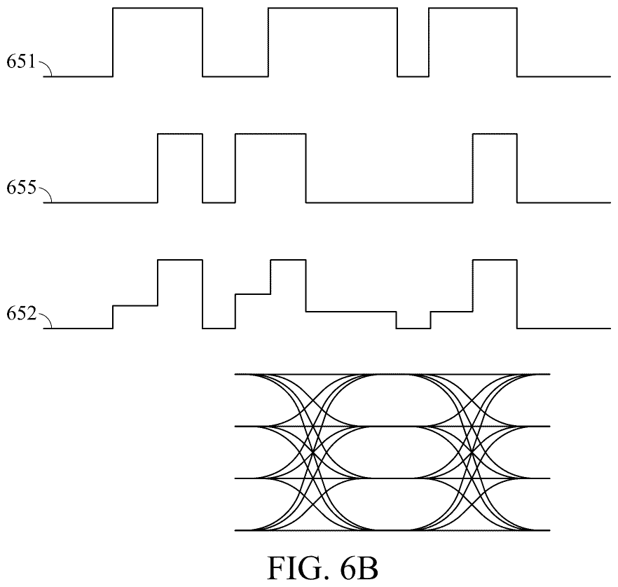

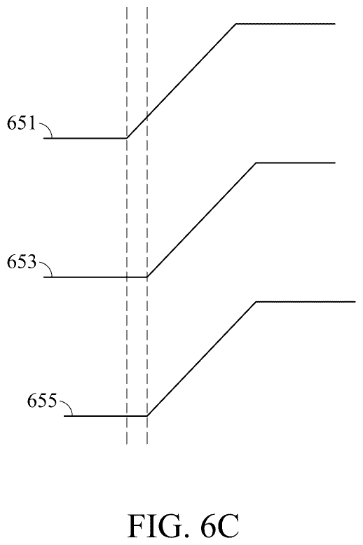

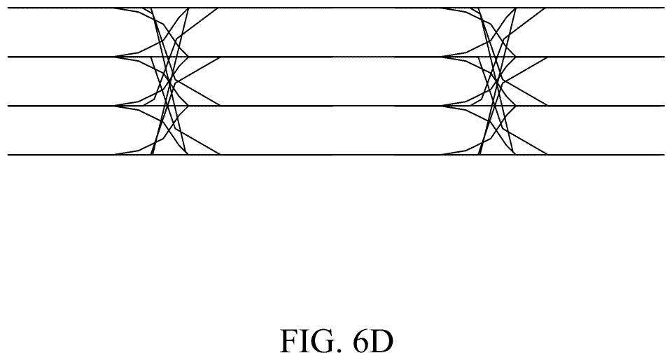

FIG. 6A illustrates a modulator 600 that may be formed and implemented as either one of the first optical components 203 (e.g., in the first active layer 201 of first optical components 203) and/or the second optical components 503 (e.g., in the first metallization layer 501 of second optical components 503). In the illustrated embodiment the modulator 600 is a Mach-Zehnder modulator that comprises two waveguides 601 formed into a splitter section 603 (wherein the waveguides 601 are close enough to evanescently couple) and a combiner section 605 (wherein the waveguides 601 are, again, close enough to evanescently couple) connected by two waveguides 601 arranged into a first connecting arm 607 and a second connecting arm 609.

In addition to the waveguides 601 being formed as illustrated, the modulator 600 additionally includes a first modulating unit 611 and a second modulating unit 613 located within the waveguides 601 within the first connecting arm 607. In an embodiment the first modulating unit 611 and the second modulating unit 613 may be formed by implanting dopants into the waveguides 601 to form doped waveguides that can be phase shifted through application of a control signal. The dopants may be implanted using one or more photolithographic masking and implanting processes. However, any suitable processes may be utilized.

Of course, the description of the first modulating unit 611 and the second modulating unit 613 being doped waveguides is intended to be illustrative and is not intended to be limiting upon the embodiments. For example, in other embodiments the first modulating unit 611 and the second modulating unit 613 may be metal resistive heaters which comprise a metal material such as copper, aluminum, etc., which can be heated through, e.g., resistive heating as a current is run through the first modulating unit 611 and the second modulating unit 613. In this embodiment the first modulating unit 611 and the second modulating unit 613 may be formed using similar processes and materials as the electrical components of the first metallization layer 501 (e.g., a damascene or dual damascene process). Any suitable structure may be utilized, and all such structures are fully intended to be included within the scope of the embodiments.

In an embodiment the first modulating unit 611 may have a first length L₁ of between about 10 μm and about 1 mm. Additionally, the second modulating unit 613 may have a second length L₂ of between about 10 μm and about 1 mm, such that a length ratio of the first length L₁ to the second length L₂ (e.g., L₁:L₂) is about 1:2. However, any suitable lengths may be utilized.

Additionally, if desired, the first modulating unit 611 and the second modulating unit 613 may be formed along a single one of the waveguides 601, or else may be formed in both the first connecting arm 607 and the second connecting arm 609. In other embodiments, however, additional modulating units may be formed in the second connecting arm 609 separately from the first modulating unit 611 and the second modulating unit 613. However, any suitable configurations may be utilized.

In order to control the first modulating unit 611, a first driver 619 is electrically connected to the first modulating unit 611 in order to drive, e.g., a first electronic data signal (represented in FIG. 6A by the arrow labeled 651) into the first modulating unit 611. In an embodiment the first driver 619 is, e.g., an inverter that receives an output from a first control circuit (represented in FIG. 6A by the box labeled 621). The first control circuit 621 is an electrical circuit that may be located either within the photonic circuit or else is located off of the photonic circuit (e.g., in a first semiconductor device 1201 seen in FIG. 12) and connected to the modulator 600 using, e.g., the first metallization layer 501.

The second modulating unit 613 is also controlled by a second driver 623 controlled by a second control circuit 625. In an embodiment the second driver 623 may be similar to the first driver 619 (e.g., an inverter), although in other embodiments the second driver 623 may be another type of driver. Similarly, the second control circuit 625 may be similar to the first control circuit 621, and in some embodiments may be the same control circuit controlling multiple drivers. Any suitable devices in any suitable configuration may be used.

Additionally illustrated in FIG. 6A, there are a number of nodes that are utilized in the discussion, such as a first node 627, a second node 629, a third node 631, and a fourth node 633. The first node 627 is located to discuss the first electrical data signal 651 between the first driver 619 and the first modulating unit 611, while the second node 629 is located to discuss an optical signal 650 between the first modulating unit 611 and the second modulating unit 613 (e.g., after it has been modulated by the first modulating unit 611 and before it arrives at the second modulating unit 613). Additionally, the third node 631 is located to discuss a second electrical data signal 655 between the second driver 623 and the second modulating unit 613, while the fourth node 633 is located to discuss the optical signal leaving the waveguide 601 and entering the combiner section 605.

FIG. 6B illustrates an idealized signal diagram that uses the first modulating unit 611 and the second modulating unit 613 in order to receive the first electrical data signal 651 and the second electrical data signal 655 to modulate the optical signal 650 and generate an output signal 652. As can be seen, by using the multiple units driven by multiple signals, the varying lengths of the phase shift results in four different modulation efficiencies. As a result, the output generates a 4-level optical signal with a PAM4 eye diagram.

However, in operation, the idealized signals encounter issues. In operation, the optical signal 650 is input into the splitter section 603 through one or both of the waveguides 601. Within the splitter section 603 the optical signal 650 evanescently couples between the waveguides 601 such that a first portion of the optical signal 650 enters the first connecting arm 607 and a second portion of the optical signal 650 enters the second connecting arm 609.

Within the first connecting arm 607, when it is desired to modulate the optical signal 650 within the first connecting arm 607, the first control circuit 621 generates the first electrical data signal 651 and sends the first electrical data signal 651 to the first driver 619 which drives the first electrical data signal 651 to the first modulating unit 611. The first modulating unit 611 receives the first electrical data signal 651 and modifies the material of the waveguide 601 through which the optical signal 650 travels. The modification of the material adjusts (e.g., lengthening or shortening) the path of the optical signal 650 through that portion of the waveguide 601 and creating a first modulated optical signal (represented in FIG. 6A by the arrow labeled 653).

Looking at FIG. 6C, FIG. 6C illustrates a signal chart of the first electrical data signal 651 through the first node 627 and the first modulated optical signal 653 through the second node 629. As can be seen, the first electrical data signal 651 will switch and also cause the first modulated optical signal 653 to switch as well. However, when the first electrical data signal 651 undergoes the first phase shift, the switching causes a latency in the electrical to optical transfer from the first electrical data signal 651 at the first node 627 to the first modulated optical signal 653 at the second node 629.

Given this latency, if the second electrical data signal 655 is transmitted by the second driver 623 (under control of the second control circuit 625) such that the second electrical data signal 655 arrives at the second modulating unit 613 simultaneously with the first electrical data signal 651 arriving at the first modulating unit 611, there will be a mismatch between the arriving signals. Such a mismatch can cause glitches to occur, thereby causing noise to be injected into the eye diagram and the overall output signal 652 from the modulator 600.

To minimize the noise and clean up the eye diagram, a first delay circuit 657 (see FIG. 6A) is introduced between the second control circuit 625 and the second driver 623 in order to provide a desired amount of delay to the second electrical data signal 655 before it is received by the second modulating unit 613. By providing the desired amount of delay, the second electrical data signal 655 will arrive at the same time as the first modulated optical signal 653 (see FIG. 6C). By timing the arrivals of these signals, the chance for glitches to occur is significantly reduced.

The first delay circuit 657 is any suitable circuitry that can be used to provide a desired and controlled amount of delay to the second electrical data signal 655. In some embodiments where the delay is known during design the first delay circuit 657 may be a passive circuit whereby the first delay circuit 657 is simply designed prior to manufacturing so that the second electrical data signal 655 has a longer route than the first electrical data signal 651. As such, the additional distance traveled provides the desired delay.

In other embodiments, the first delay circuit 657 may provide an active, controllable delay to the second electrical data signal 655. For example, in an embodiment in which the first delay circuit 657 is an active delay circuit, the first delay circuit 657 may include a delay chain and a regulator which regulates power to the delay chain. In this embodiment the delay of the second electrical data signal 655 traversing the delay chain will be adjusted based on the power level provided by the regulator. However, any suitable circuitry or other structures may be used for the first delay circuit 657, and all such structures and methods for providing the desired delay are fully intended to be included within the scope of the embodiments.

Returning back to FIG. 6C, by delaying the second electrical data signal 655, the arrival of the second electrical data signal 655 may be timed to arrive at a similar time as the first modulated optical signal 653. In some embodiments the time delay to be applied may be determined using the following equations:

$$Time delay = \frac{L}{Vg}$$

where L is the optical path length and Vg is determined by the following equation:

$$Vg = \frac{C}{ng}$$

where Ng is the optical group index in the waveguide 601.

By utilizing the first delay circuit 657, a better, more clean eye can be obtained, as illustrated in FIG. 6D. In particular, by reducing or eliminating the number of glitches that occur due to a mismatch in signal propagation, the overall eye can be made cleaner, and fewer issues related to mismatch can be obtained.

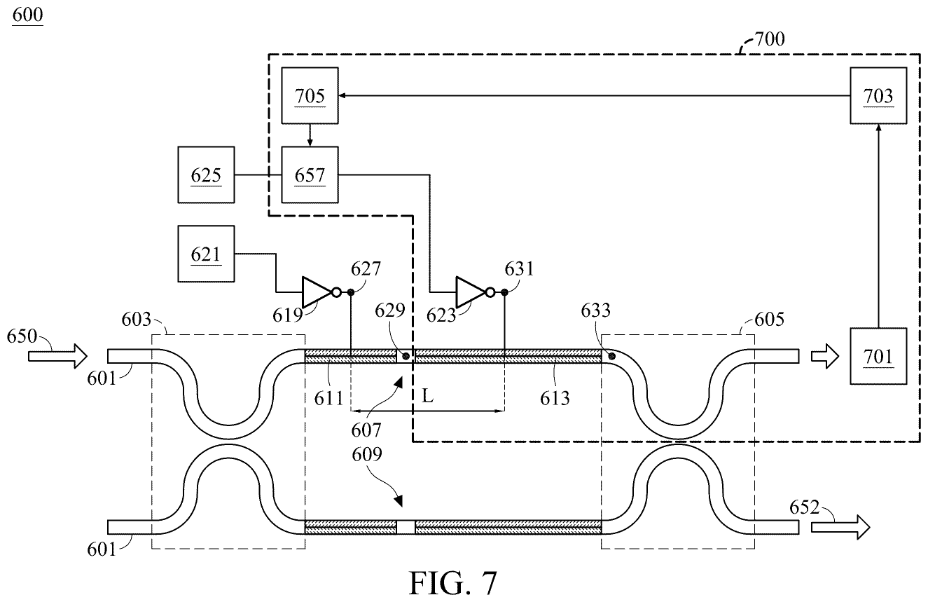

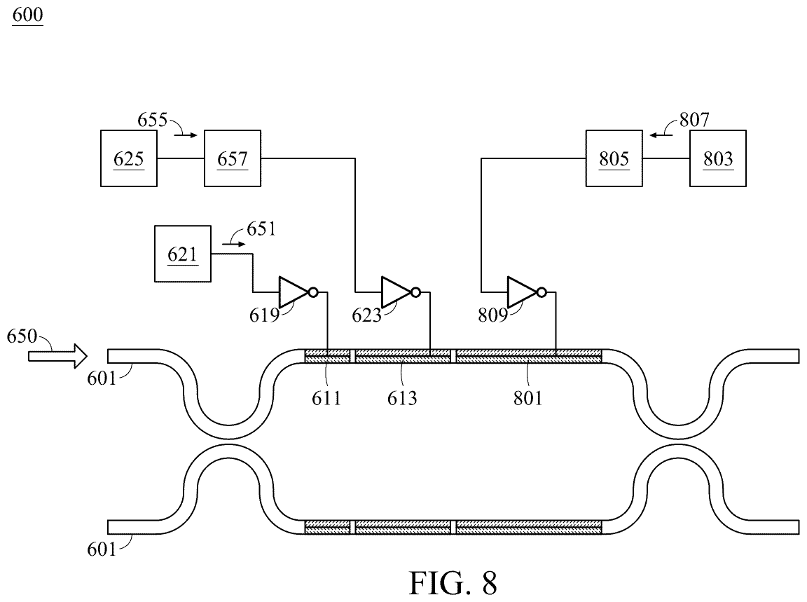

FIG. 7 illustrates another embodiment which utilizes a first delay control loop 700 that can be used to automatically adjust the delay time and helping to reduce the occurrence of glitches. In this embodiment, an optical monitor 701 and a comparator 703 are utilized in order to provide a real-time input into a delay control circuit 705 that can provide the desired control to the first delay circuit 657. Looking first at the optical monitor 701, the optical monitor 701 receives one of the outputs from the modulator 600 and translates the optical output signal into an electrical signal. In some embodiments the optical monitor 701 may be a modulator such as a photodiode, although any other suitable monitoring devices may be utilized.

Once the optical monitor 701 has converted the optical output signal from the modulator 600 into an electrical signal, the electrical signal is transferred to the comparator 703. The comparator 703 may be used to receive the electrical signal and compare it to a standard, looking for the presence or absence of a glitch caused by the mismatch of the electrical signals applied to the first modulating unit 611 and the second modulating unit 613. The comparator 703 then sends an output signal to the delay control circuit 705.

The delay control circuit 705 receives the output signal from the comparator 703 and determines what signal to send to the first delay circuit 657. For example, in an embodiment in which the first delay circuit 657 is a delay chain, the delay control circuit 705 may decide the voltage to be applied to the delay chain in order to control the delay. However, any suitable delay control circuit 705 providing any suitable signal to control the first delay circuit 657 may be utilized.

By utilizing the first delay control loop 700 illustrated in FIG. 7, process variations that can cause the optical group index in the waveguide 601 (Ng) to not be a constant value can be dealt with. In particular, the delay control loop can be used to automatically adjust the delay time. As such, further reductions in the occurrence of glitches can be obtained.

FIG. 8 illustrates an embodiment that uses a PAM8 modulator which utilizes three sections, including the first modulating unit 611 (controlled by the first control circuit 621), the second modulating unit 613 (controlled by the second control circuit 625 and delayed by the first delay circuit 657), and a third modulating unit 801. In this embodiment, the first modulating unit 611 remains controlled by the first electrical data signal 651 from the first control circuit 621, the second modulating unit 613 remains controlled by the second electrical data signal 655 delayed by the first delay circuit 657, and the third modulating unit 801 is controlled by a third electrical data signal 807 from a third control circuit 803 (similar to the first control circuit 621), delayed by a second delay unit 805 (similar to the first delay circuit 657), and driven by a third driver 809 (similar to the first driver 619). In an embodiment the first delay circuit 657 and the second delay unit 805 may delay their respective signals independently of each other, such that the delay signals may independently adjust their signals.

By using a different number of segments, higher levels of pulse amplitude modulation may be achieved. For example, for a PAM4 structure, there are two segments (e.g., the first modulating unit 611 and the second modulating unit 613) with two drivers, wherein the length ratio of the first segment and the second segment (e.g., L₁:L₂) is 1:2. Similarly, for a PAM8 structure, there are three segments (e.g., the first modulating unit 611, the second modulating unit 613, and the third modulating unit 801) with three drivers, wherein the length ratio of the first segment, the second segment, and the third segment (e.g., L₁:L₂:L₃) is 1:2:4. More generically, for any desired pulse amplitude modulation structure PAMX in which there are N number of segments, there are N number of drivers (one for each segment) and the segments have a length ratio (L₁:L₂: . . . :Ln) of 1:2: . . . :2^{(N-1)}. However, any suitable structure with any suitable number of segments may be utilized.

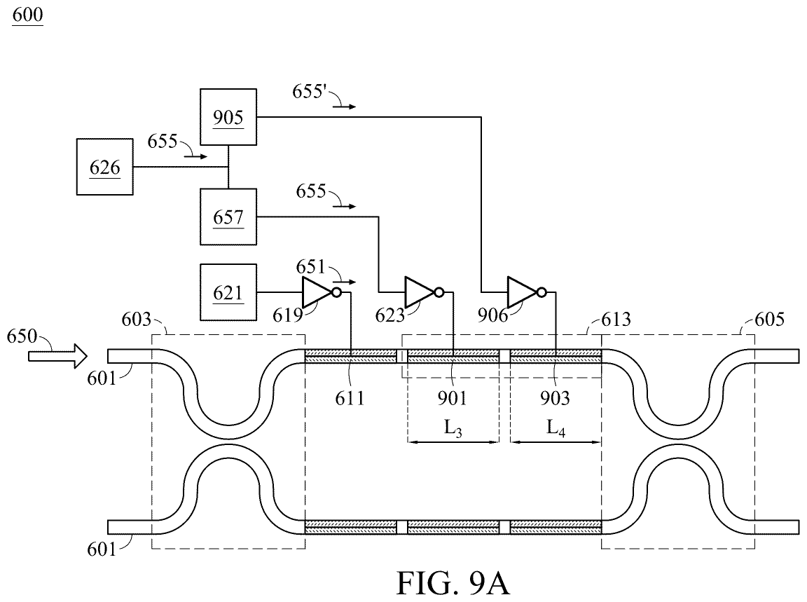

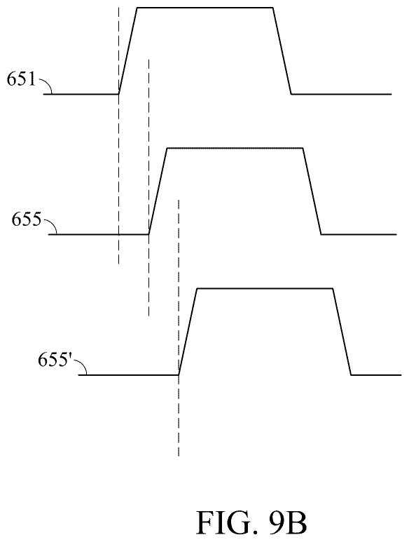

FIG. 9A illustrates another embodiment which utilizes the first modulating unit 611 and the second modulating unit 613, but in which the length of the second modulating unit 613 is so long that the length may cause additional problems with delay. As such, in this embodiment, the second modulating unit 613 may be split into a first portion 901 and a second portion 903, which both receive the second electrical data signal 655 through the second driver 623 and a fourth driver 906 (similar to the first driver 619).

However, because of the delay problems caused by the length of the second modulating unit 613, the second electrical data signal 655 may be independently delayed on its way to the first portion 901 and the second portion 903. For example, the second control circuit 625 may generate and send the second electrical data signal 655 to the first portion 901 through the first delay circuit 657 (as described above with respect to FIG. 6A). However, in this embodiment the second control circuit 625 may send the second electrical data signal 655 to the second portion 903 through a second delay circuit 905, which may be similar to the first delay circuit 657 but which may or may not delay the second electrical data signal 655 by a different amount than the first delay circuit 657. As such, the same second electrical data signal 655 will reach both the first portion 901 and the second portion 903, but at different delays, thereby reducing or eliminating glitches that can occur.

In this embodiment the first modulating unit 611 and the second modulating unit 613 (including both the first portion 901 and the second portion 903) retain the length ratio L₁:L₂ discussed above. However, because the second modulating unit 613 is split into the first portion 901 and the second portion 903, a third length L₃ of the first portion 901 and a fourth length L₄ of the second portion 903 add together to meet the length ratio such that L₁:(L₃+L₄) is about 1:2. For example, when the first modulating unit 611 has the first length L₁, the third length L₃ of the first portion 901 and the fourth length L₄ of the second portion 903 of the second modulating unit 613 may each be the first length L₁. In other embodiments in which the first modulating unit 611 has the first length L₁, the third length L₃ of the first portion 901 may have one-half of the first length L₁ while the fourth length L₄ of the second portion 903 is 1.5 times the first length L₁.

Additionally, in embodiments in which the segment lengths are the same, the delay time will be the same through each segment. However, in embodiments in which the segment lengths are not the same, the delay time will be proportional to the lengths of the individual segments. For example, in embodiments in which the third length L₃ of the first portion 901 is one-half of the first length L₁, while the fourth length L₄ of the second portion 903 is 1.5 times the first length L₁, the delay applied to the first portion 901 should be one-half of the delay through the first modulating unit 611 and the delay applied to the second portion 903 should be 1.5 times the delay through the first modulating unit 611. However, any suitable delays may be utilized.

FIG. 9B illustrates a timing diagram that can be used with the structure illustrated in FIG. 9A. As can be seen this diagram, the first electrical data signal 651 is applied to the first modulating unit 611 and the second electrical data signal 655 (delayed by the first delay circuit 657) is applied to the first portion 901 of the second modulating unit 613. Additionally, however, the second electrical data signal 655 delayed by the second delay circuit 905 (represented by the label 655′) is applied to the second portion 903 of the second modulating unit 613.

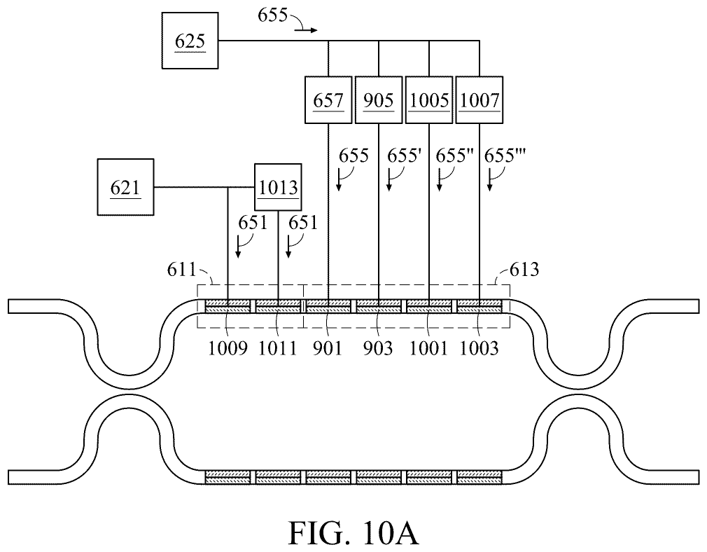

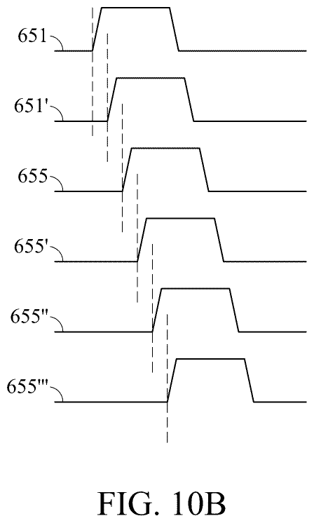

FIGS. 10A-10B illustrate a further expansion of the idea in FIGS. 9A-9B, in which the second modulating unit 613 is further split into not just the first portion 901 and the second portion 903, but also a third portion 1001 and a fourth portion 1003. In this embodiment the second electrical data signal 655 is sent to each of the first portion 901, the second portion 903, the third portion 1001, and the fourth portion 1003, but the second electrical data signal 655 is delayed by the first delay circuit 657 to the first portion 901 (represented by the arrow labeled 655 in FIG. 10A), delayed by the second delay circuit 905 to the second portion 903 (represented by the arrow labeled 655′ in FIG. 10A), delayed by a third delay circuit 1005 (similar to the second delay circuit 905) to the third portion 1001 (represented by the arrow labeled 655″ in FIG. 10A), and delayed by a fourth delay circuit 1007 (similar to the second delay circuit 905) to the fourth portion 1003 (represented by the arrow labeled 655′″ in FIG. 10A). Each of the first delay circuit 657, the second delay circuit 905, the third delay circuit 1005, and the fourth delay circuit 1007 apply a different and independent delay to the second electrical data signal 655 along the path to the first portion 901, the second portion 903, the third portion 1001, and the fourth portion 1003 of the second modulating unit 613.

Additionally in this embodiment the first modulating unit 611 may also be split into multiple portions, such as a fifth portion 1009 and a sixth portion 1011, that each receives the first electrical data signal 651 from the first control circuit 621. In this embodiment, however, while the fifth portion 1009 may receive the first electrical data signal 651 undelayed from the first control circuit 621 (represented by the arrow labeled 651 in FIG. 10A), the sixth portion 1011 may receive the first electrical data signal 651 delayed by a fifth delay circuit 1013 (similar to the first delay circuit 657) (represented by the arrow labeled 651′ in FIG. 10A). However, any suitable number of segments may be utilized.

FIG. 10B illustrates a delay diagram for the structure in FIG. 10A. As can be seen this diagram, the first electrical data signal 651 is applied to the fifth portion 1009 of the first modulating unit 611 and to the sixth portion 1011 of the first modulating unit 611 (represented by the arrow labeled 651′ in FIG. 10B). Additionally, the second electrical data signal 655 is applied to the first portion 901 (delayed by the first delay circuit 657), is applied to the second portion 903 (delayed by the second delay circuit 905) (represented by the arrow labeled 655′ in FIG. 10B), is applied to the third portion 1001 (delayed by the third delay circuit 1005) (represented by the arrow labeled 655″ in FIG. 10B), and is applied to the fourth portion 1003 (delayed by the fourth delay circuit 1007) (represented by the arrow labeled 655′″ in FIG. 10B).

The amount of delay being introduced can be based on the individual lengths of the first portion 901, the second portion 903, the third portion 1001, the fourth portion 1003, the fifth portion 1009, and the sixth portion 1011. For example, in embodiments in which the length ratio of the first modulating unit 611 (in total) and the second modulating unit 613 (in total) remains 1:2, and in which each of the first portion 901, the second portion 903, the third portion 1001, the fourth portion 1003, the fifth portion 1009, and the sixth portion 1011 are equal lengths to each other, the amount of delay added is equal between each portion. However, any suitable delay may be utilized.

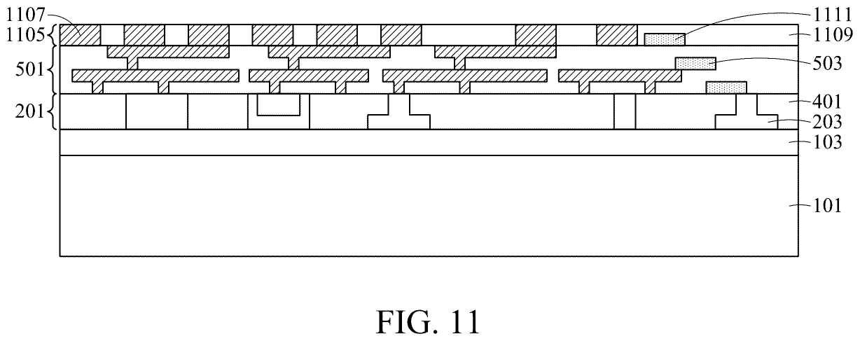

FIG. 11 illustrates that, once the first metallization layers 501 with those portions of the modulator 600 within the first metallization layers 501 have been manufactured, an optional first bonding layer 1105 is formed over the first metallization layers 501. In an embodiment, the first bonding layer 1105 may be used for a dielectric-to-dielectric and metal-to-metal bond. In accordance with some embodiments, the first bonding layer 1105 is formed of a first dielectric material 1109 such as silicon oxide, silicon nitride, or the like. The first dielectric material 1109 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 1109 has been formed, first openings in the first dielectric material 1109 are formed to expose conductive portions of the underlying layers in preparation to form first bond pads 1107 within the first bonding layer 1105. Once the first openings have been formed within the first dielectric material 1109, the first openings may be filled with a seed layer and a plate metal to form the first bond pads 1107 within the first dielectric material 1109. The seed layer may be blanket deposited over top surfaces of the first dielectric material 1109 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 1109 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 1107 within the first bonding layer 1105. In some embodiments a bond pad via (not separately illustrated) may also be utilized to connect the first bond pads 1107 with underlying conductive portions and, through the underlying conductive portions, connect the first bond pads 1107 with the first metallization layers 501.

Additionally, the first bonding layer 1105 may also include one or more third optical components 1111 incorporated within the first bonding layer 1105. In such an embodiment, prior to the deposition of the first dielectric material 1109, the one or more third optical components 1111 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 12 illustrates a bonding of a first semiconductor device 1201 to the first bonding layer 1105. In some embodiments, the first semiconductor device 1201 is an electronic integrated circuit (EIC—e.g., a device without optical devices) and may have a semiconductor substrate 1203, a layer of active devices (not separately illustrated), an overlying interconnect structure (also not separately illustrated), a second bonding layer 1209, and associated third bond pads 1211. In an embodiment the semiconductor substrate 1203 may be similar to the first substrate 101 (e.g., a semiconductor material such as silicon or silicon germanium), the active devices may be transistors, capacitors, resistors, and the like formed over the semiconductor substrate 1203, the interconnect structure may be similar to the first metallization layers 501 (without optical components), the second bonding layer 1209 may be similar to the first bonding layer 1105, and the third bond pads 1211 may be similar to the first bond pads 1107. However, any suitable devices may be utilized.

In an embodiment the first semiconductor device 1201 may be configured to work with the photonic integrated circuit 100 for a desired functionality. In some embodiments the first semiconductor device 1201 may be a logic die, or a high bandwidth memory (HBM) module, that is utilized in order to provide control signals and/or other signals to the first optical components 203 and the second optical components 503, such as the first electrical data signal 651 and the second electrical data signals 655. However, in other embodiments the first semiconductor device 1201 may be an xPU, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 1201 and the first bonding layer 1105 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 1209 and the surfaces of the first bonding layer 1105. Activating the top surfaces of the first bonding layer 1105 and the second bonding layer 1209 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 1105 and the second bonding layer 1209.

After the activation process the photonic integrated circuit 100 and the first semiconductor device 1201 may be cleaned using, e.g., a chemical rinse, and then the first semiconductor device 1201 is aligned and placed into physical contact with the photonic integrated circuit 100. The photonic integrated circuit 100 and the first semiconductor device 1201 are then subjected to thermal treatment and contact pressure to bond the photonic integrated circuit 100 and the first semiconductor device 1201. For example, the photonic integrated circuit 100 and the first semiconductor device 1201 may be subjected to a pressure of about 200 kPa or less, and a temperature between about 25° C. and about 250° C. to fuse the photonic integrated circuit 100 and the first semiconductor device 1201. The photonic integrated circuit 100 and the first semiconductor device 1201 may then be subjected to a temperature at or above the eutectic point for material of the first bond pads 1107 and the third bond pads 1211, e.g., between about 150° C. and about 650° C., to fuse the metal. In this manner, the photonic integrated circuit 100 and the first semiconductor device 1201 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

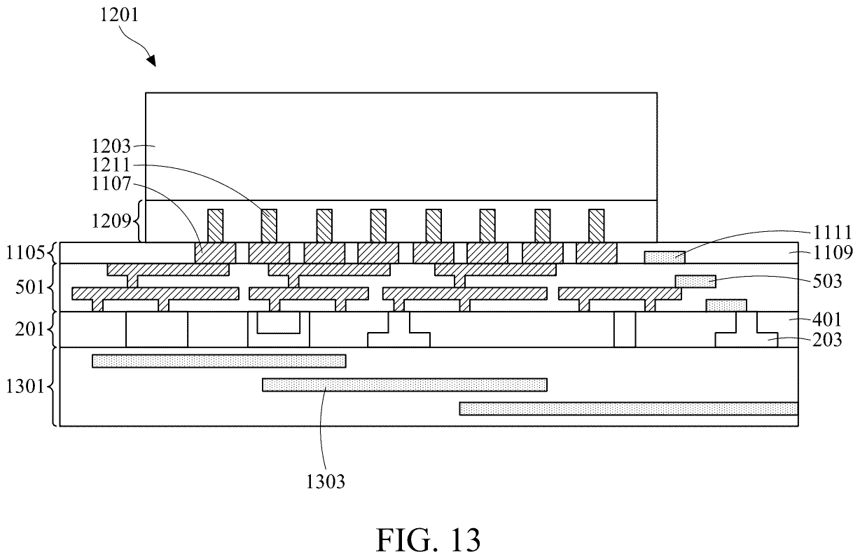

FIG. 13 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 1301 of fourth optical components 1303 may be formed on a back side of the first active layer 201. In an embodiment the second active layer 1301 of fourth optical components 1303 may be formed using similar materials and similar processes as the second optical components 503 of the first metallization layers 501 (described above with respect to FIG. 5). For example, the second active layer 1301 of fourth optical components 1303 may be formed of alternating layers of a cladding material such as silicon oxide and core material such as silicon nitride formed using deposition and patterning processes in order to form optical components such as waveguides and the like.

FIG. 14 illustrates formation of second through device vias (TDVs) 1401 and formation of a third bonding layer 1403 to complete the photonic integrated circuit 100 and form a first optical package 1400 (with both the photonic integrated circuit 100 and the first semiconductor device 1201). In an embodiment the second through device vias 1401 extend through the second active layer 1301 and the first active layer 201 so as to provide a quick passage of power, data, and ground through the photonic integrated circuit 100. In an embodiment the second through device vias 1401 may be formed by initially forming through device via openings into the photonic integrated circuit 100. The through device via openings may be formed by applying and developing a suitable photoresist (not shown), and removing portions of the second active layer 1301 and the photonic integrated circuit 100 that are exposed.

Once the through device via openings have been formed within the photonic integrated circuit 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the second through device vias 1401 have been formed, second metallization layers (not separately illustrated in FIG. 14) may be formed in electrical connection with the second through device vias 1401. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 1403 is formed in order to provide electrical connections between the photonic integrated circuit 100 and subsequently attached devices. In an embodiment the third bonding layer 1403 may be similar to the first bonding layer 1105, such as having third bond pads 1409 (similar to the first bond pads 1107) and even fifth optical components 1411 (similar to the third optical components 1111). However, any suitable devices may be utilized.

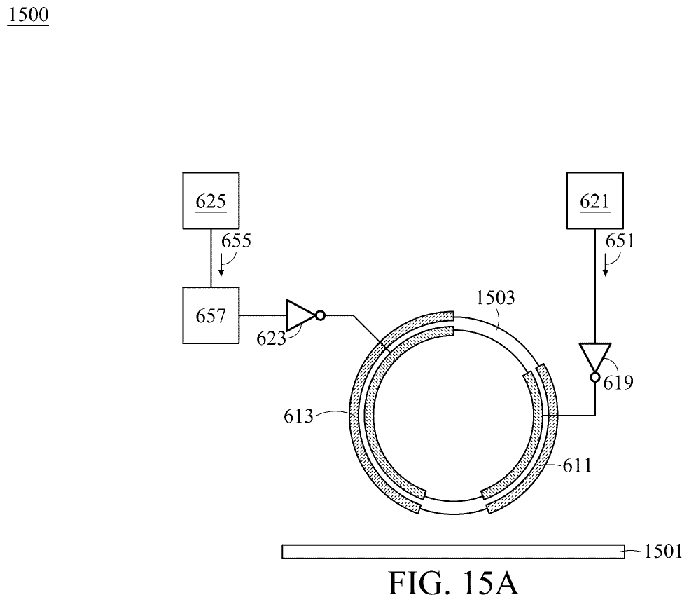

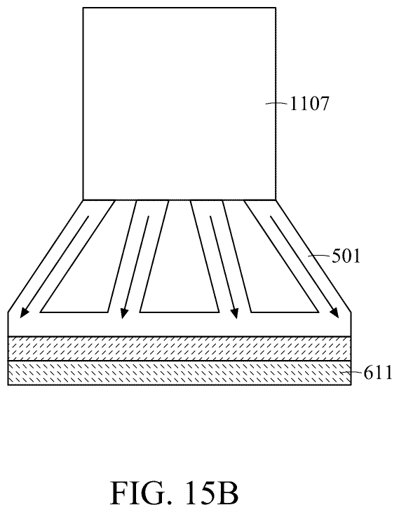

FIG. 15A illustrates another embodiment using the first modulating unit 611 and the second modulating unit 613 in, e.g., a micro-ring modulator (MRM) 1500. In this embodiment the MRM 1500 comprises a first waveguide 1501 and a ring 1503 (comprising another waveguide) adjacent to the first waveguide 1501. Additionally, in order to achieve the desired pulse amplitude modulation (PAMX), the first modulating unit 611 and the second modulating unit 613 are applied in order to adjust the modulation as optical signals traverse through the MRM 1500. For example, in some embodiments the optical signals traverse from the first waveguide 1501, are coupled into the ring 1503, are delayed by the ring 1503 (wherein the inherent delay of traveling through the ring 1503 is additionally adjusted by the first modulating unit 611 and the second modulating unit 613), and then coupled back into the first waveguide 1501.

Additionally, in order to minimize the amount of glitches that can occur, the first electrical data signal 651 can be sent from the first control circuit 621 directly to the first modulating unit 611 (through the first driver 619) while the second electrical data signal 655 can be sent from the second control circuit 625 through the first delay circuit 657 (where it is delayed) to the second modulating unit 613 (through the second driver 623). By delaying the signal, fewer glitches can occur and the overall efficiency of the MRM 1550 can be improved.

FIG. 15B illustrates a conceptual idea of further improvements that can be applied to the either the first modulating unit 611 and/or the second modulating unit 613 (with FIG. 15B illustrating only the first modulating unit 611 for clarity). In this embodiment, in order to further decrease the latency in the electrical to optical transfer, the path of the driver signal (e.g., the first electrical data signal 651) to the first modulating unit 611 can be made shorter. In particular, in the embodiment illustrated, electrical paths from the first bond pad 1107 (which receives the first electrical data signal 651 from the first driver 619 on the first semiconductor device 1201) may be split in order to make physical contact with the first modulating unit 611 at multiple points. While four points are illustrated in FIG. 15B, any suitable number of contact points may be utilized.

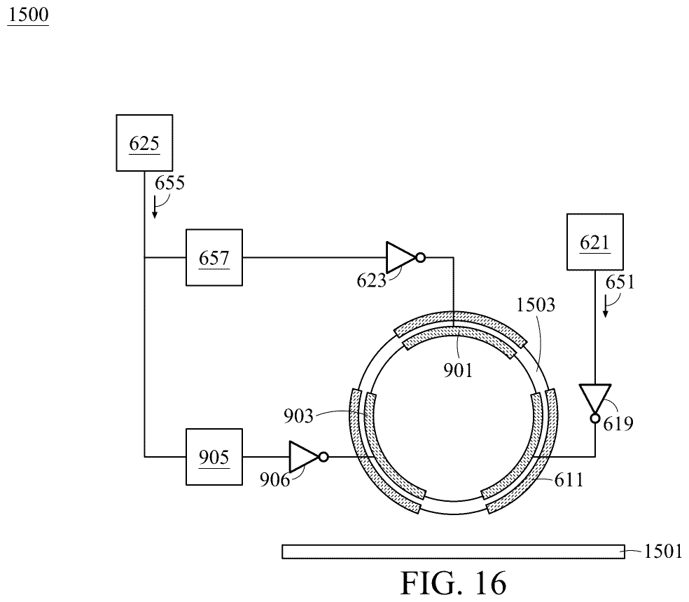

FIG. 16 illustrates another embodiment of the MRM 1500 described above with respect to FIGS. 15A-15B. In this embodiment, the second modulating unit 613 is split into the first portion 901 (which receives the second electrical data signal 655 delayed through the first delay circuit 657) and the second portion 903 (which receives the second electrical data signal 655 through the second delay circuit 905). In an embodiment the first portion 901 and the second portion 903 are implemented as described above with respect to FIG. 9. However, any suitable structures may be utilized.

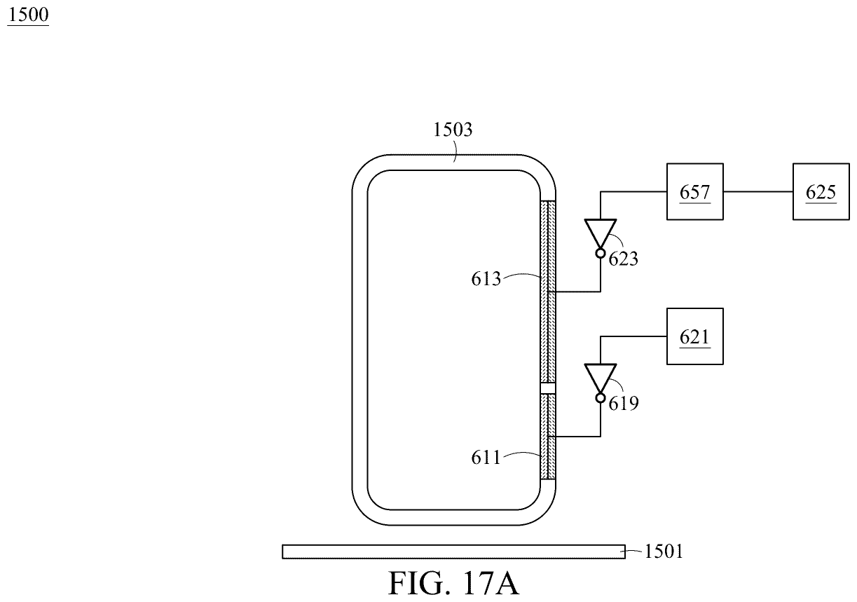

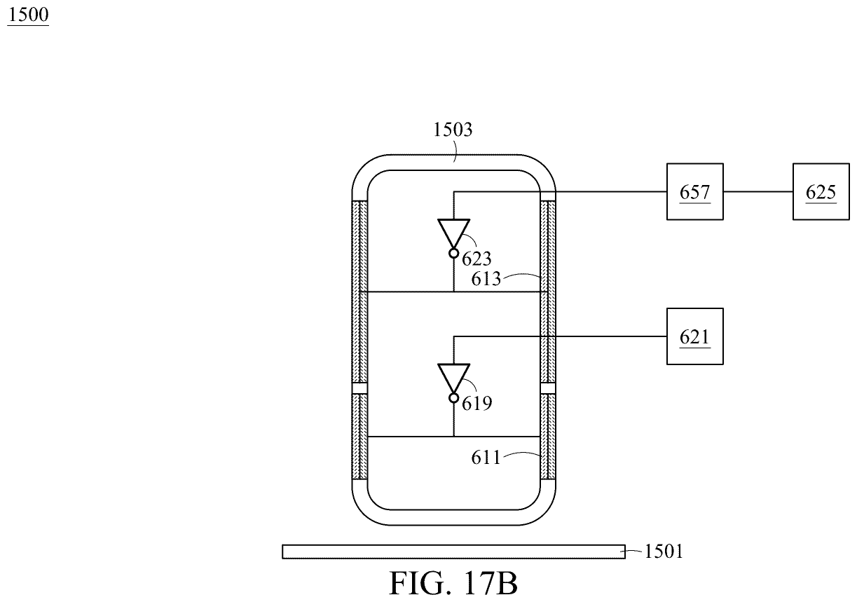

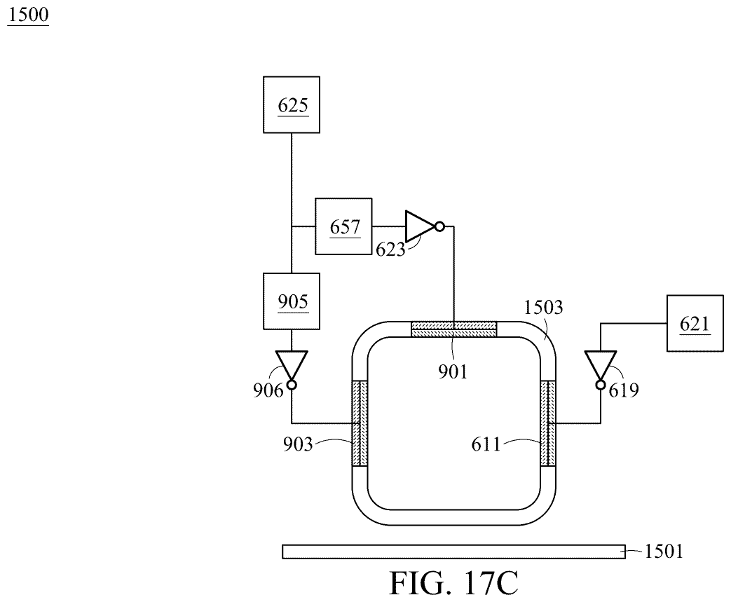

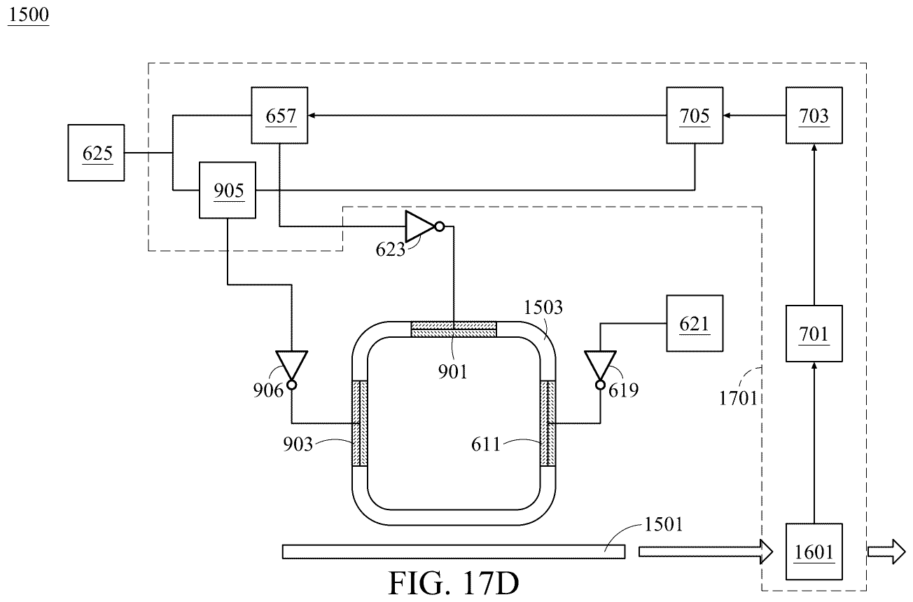

FIGS. 17A-17C illustrate yet other embodiments in which the first modulating unit 611 and the second modulating unit 613 are utilized with micro-ring modulators. In these embodiments, however, instead of a high speed MRM with a circular ring (as described above with respect to FIGS. 15A-16), the ring 1503 is elongated in a low-power, high Q runway schematic. In FIG. 17A there is illustrated an embodiment in which the first modulating unit 611 and the second modulating unit 613 are formed on a first side of the MRM 1500, wherein both the first modulating unit 611 and the second modulating unit 613 are single segments each.

Looking next at the embodiment illustrated in FIG. 17B, there is illustrated another embodiment in which the first modulating unit 611 and the second modulating unit 613 are formed on the MRM 1500. In this embodiment, however, the first modulating unit 611 and the second modulating unit 613 are formed on multiple sides of the MRM 1500, wherein both the first modulating unit 611 and the second modulating unit 613 are single segments each. Any suitable configuration and placement may be utilized.

FIG. 17C illustrates another embodiment in which the first modulating unit 611 and the second modulating unit 613 are used with the MRM 1500. In this embodiment, however, the second modulating unit 613 is separated into the first portion 901 and the second portion 903, as described above with respect to FIG. 9A. However, any suitable configuration may be utilized.

FIG. 17D illustrates another embodiment similar to the embodiment illustrated in FIG. 17C, but in which a second delay control loop 1701 is included to provide an active delay control. In an embodiment the second delay control loop 1701 comprises the optical monitor 701, the comparator 703, and the delay control circuit 705 that are utilized to provide feedback information to the first delay circuit 657 and the second delay circuit 905. In this embodiment, however, because there is a single output from the first waveguide 1501, the delay loop additionally comprises a first splitter 1603. In an embodiment the first splitter 1603 may be similar to the splitter section 603 (described above with respect to FIG. 6A), such as by being two waveguides placed closed enough together to allow for evanescent coupling between the waveguides. However, any suitable structure may be utilized.

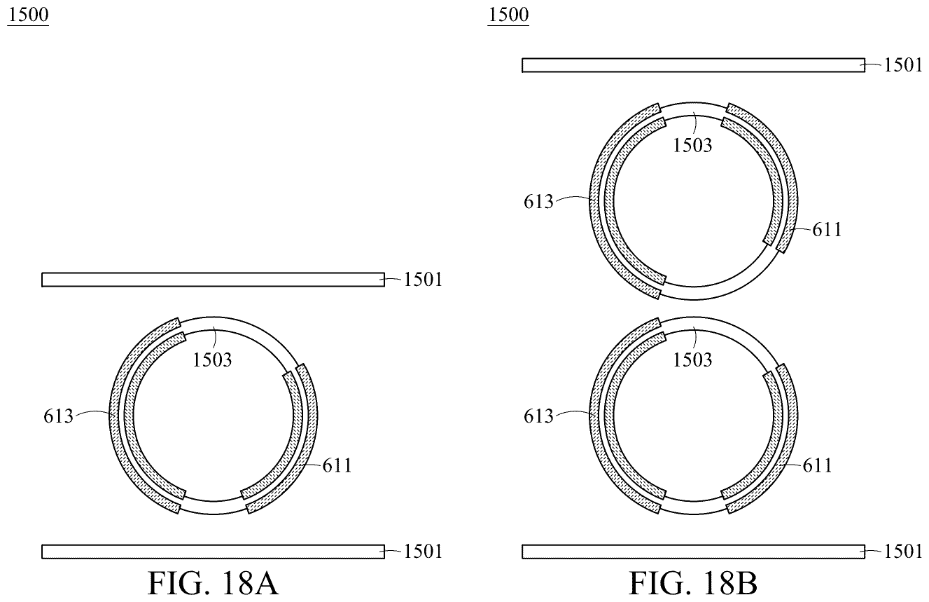

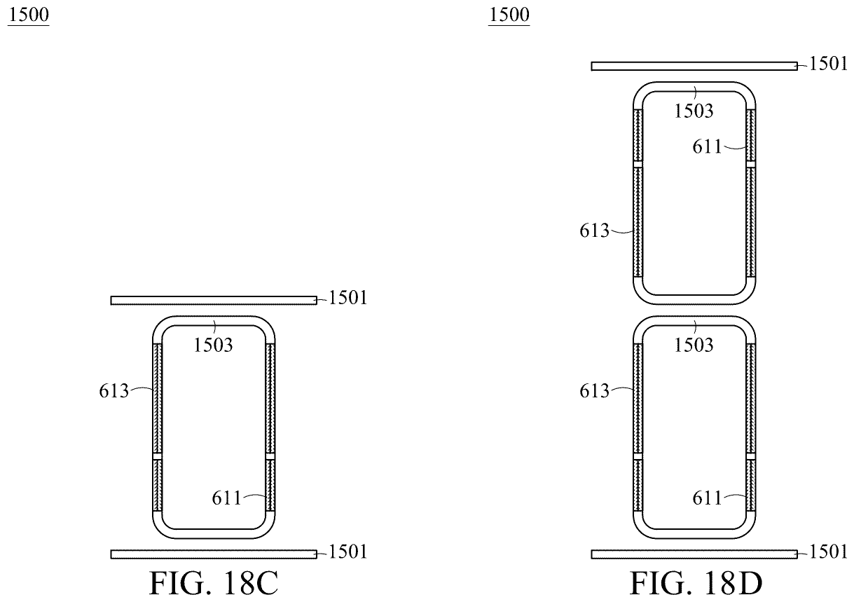

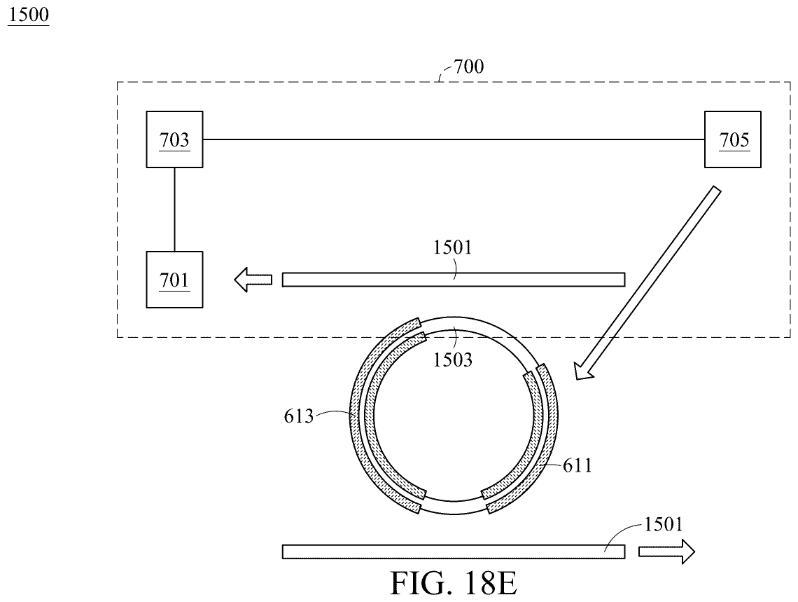

FIGS. 18A-18E illustrate further embodiments which utilize the first modulating unit 611 and the second modulating unit 613 with the MRM 1500, with extraneous structures removed from the figures for clarity. In these embodiments, however, the MRM 1500 is a drop ring (FIG. 18A), a double ring (FIG. 18B), an elongated drop ring (FIG. 18C), an elongated double ring (FIG. 18D). As illustrated, both the first modulating unit 611 and the second modulating unit 613 are utilized as described above with respect to FIGS. 1-17D (with only the single segment embodiments being illustrated for clarity). However, any suitable configurations may be utilized.

FIG. 18E illustrates another embodiment similar to the embodiment illustrated in FIG. 18A, but in which the first delay control loop 700 is included to provide for an active delay control. In an embodiment the first delay control loop 700 comprises the optical monitor 701, the comparator 703, and the delay control circuit 705 that are utilized to provide feedback information to, eventually, the first modulating unit 611 and the second modulating unit 613 (wherein FIG. 18E illustrates a simplified version with structures such as the delay control circuits and drivers being omitted). In this embodiment, the optical monitor 701 receives an output signal from one first waveguide 1501 while the other first waveguide 1501 provides an output from the MRM 1500. However, any suitable structure may be utilized.

By utilizing the various delay circuits (e.g., the first delay circuit 657, the second delay circuit 905, etc.) in order to better time the arrival of data signals to the first modulating unit 611, the second modulating unit 613, etc., a more precise delivery of data signals can be achieved. As such, fewer glitches occur that are caused by this mismatch in timing, and a better, more clean eye can be obtained. In particular, by reducing or eliminating the number of glitches that occur due to a mismatch in signal propagation, the overall eye can be made cleaner, and fewer issues related to mismatch can be obtained.

In an embodiment, an optical device includes: a first optical modulator including: a first modulating portion; and a second modulating portion; a first driver electrically connected to the first modulating portion; a second driver electrically connected to the second modulating portion; and a first delay circuit connected to the second driver. In an embodiment the optical device further includes: a first control circuit connected to the first driver without a delay circuit between the first control circuit and the first driver; and a second control circuit connected to the first delay circuit. In an embodiment the optical device further includes a feedback loop providing an input signal to the first delay circuit. In an embodiment the optical device further includes: a third modulating portion of the first optical modulator; and a third driver electrically connected to the third modulating portion; and a second delay circuit connected to the third driver. In an embodiment the second delay circuit is connected to the second control circuit. In an embodiment the optical device further includes a third control circuit connected to the third driver, the third control circuit being different from the second control circuit. In an embodiment the first optical modulator is a Mach-Zehnder switch.

In another embodiment, an optical device includes: a first control circuit connected to a first driver connected to a first portion of a first waveguide; and a second control circuit connected to a first delay circuit connected to a second driver connected to a second portion of the first waveguide, the second control circuit being different from the first control circuit. In an embodiment the optical device further includes a third control circuit connected to a second delay circuit connected to a third driver connected to a third portion of the first waveguide. In an embodiment the optical device further includes a second delay circuit connected to a third driver connected to a third portion of the first waveguide, the second delay circuit connected to the second control circuit. In an embodiment the first waveguide is part of a Mach-Zehnder switch. In an embodiment the first waveguide is part of a micro-ring modulator. In an embodiment the first waveguide is circular. In an embodiment the first waveguide is an elongated oval.

In yet another embodiment a method includes: generating a first electronic data signal and sending the first electronic data signal to a first modulating section of a first optical modulator; generating a second electrical data signal and sending the second electrical data signal to a first delay circuit; delaying the second electrical data signal to create a delayed second electronic data signal; and sending the delayed second electronic data signal to a second modulating section of the first optical modulator. In an embodiment the method further includes generating a third electronic data signal and sending the third electronic data signal to a second delay circuit different from the first delay circuit. In an embodiment the method further includes: sending the second electronic data signal to a second delay circuit different from the first delay circuit; delaying the second electronic data signal to create a third electronic data signal; and sending the third electronic data signal to a third modulating section of the first optical modulator. In an embodiment the method further includes: receiving an optical output from the first optical modulator; converting the optical output to an electrical signal; comparing the electrical signal and generating a feedback signal; and sending the feedback signal to the first delay circuit. In an embodiment the first optical modulator is part of a Mach-Zehnder switch. In an embodiment the first optical modulator is part of a ring modulator.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device comprising:
a first optical modulator comprising:
a first modulating portion; and
a second modulating portion;
a first driver electrically connected to the first modulating portion;
a second driver electrically connected to the second modulating portion; and
a first delay circuit connected to the second driver.

2. The optical device of claim 1, further comprising:
a first control circuit connected to the first driver without a delay circuit between the first control circuit and the first driver; and
a second control circuit connected to the first delay circuit.

3. The optical device of claim 2, further comprising a feedback loop providing an input signal to the first delay circuit.

4. The optical device of claim 2, further comprising:
a third modulating portion of the first optical modulator; and
a third driver electrically connected to the third modulating portion; and
a second delay circuit connected to the third driver.

5. The optical device of claim 4, wherein the second delay circuit is connected to the second control circuit.

6. The optical device of claim 4, further comprising a third control circuit connected to the third driver, the third control circuit being different from the second control circuit.

7. The optical device of claim 1, wherein the first optical modulator is a Mach-Zehnder switch.

8. An optical device comprising:
a first control circuit connected to a first driver connected to a first portion of a first waveguide; and
a second control circuit connected to a first delay circuit connected to a second driver connected to a second portion of the first waveguide, the second control circuit being different from the first control circuit.

9. The optical device of claim 8, further comprising a third control circuit connected to a second delay circuit connected to a third driver connected to a third portion of the first waveguide.

10. The optical device of claim 8, further comprising a second delay circuit connected to a third driver connected to a third portion of the first waveguide, the second delay circuit connected to the second control circuit.

11. The optical device of claim 8, wherein the first waveguide is part of a Mach-Zehnder switch.

12. The optical device of claim 8, wherein the first waveguide is part of a micro-ring modulator.

13. The optical device of claim 12, wherein the first waveguide is circular.

14. The optical device of claim 12, wherein the first waveguide is an elongated oval.

15. A method comprising:
generating a first electronic data signal and sending the first electronic data signal to a first modulating section of a first optical modulator;
generating a second electrical data signal and sending the second electrical data signal to a first delay circuit;
delaying the second electrical data signal to create a delayed second electronic data signal; and
sending the delayed second electronic data signal to a second modulating section of the first optical modulator.

16. The method of claim 15, further comprising generating a third electronic data signal and sending the third electronic data signal to a second delay circuit different from the first delay circuit.

17. The method of claim 15, further comprising:
sending the second electronic data signal to a second delay circuit different from the first delay circuit;
delaying the second electronic data signal to create a third electronic data signal; and
sending the third electronic data signal to a third modulating section of the first optical modulator.

18. The method of claim 15, further comprising:
receiving an optical output from the first optical modulator;
converting the optical output to an electrical signal;
comparing the electrical signal and generating a feedback signal; and
sending the feedback signal to the first delay circuit.

19. The method of claim 15, wherein the first optical modulator is part of a Mach-Zehnder switch.

20. The method of claim 15, wherein the first optical modulator is part of a ring modulator.
